(19) United States
(12) Patent Application Publication
(10) Pub. No.: US 2013/0266491 A1
(43) Pub. Date: Oct. 10, 2013

(54) CHIP FOR ANALYSIS OF SOLUTION OF INTEREST

(71) Applicant: Tomoyuki Murata, Kyoto-shi (JP)

(72) Inventor: Tomoyuki Murata, Kyoto-shi (JP)

(73) Assignee: HORIBA, LTD., Kyoto-shi, Kyoto (JP)

(21) Appl. No.: 13/995,114

(22) PCT Filed: Dec. 16, 2011
(86) PCT No.: PCT/JP2011/079169

§ 371 Date: Jun. 17, 2013

(30) Foreign Application Priority Data
Dec. 17, 2010 (JP) 2010-282188

(51) Int. Cl. B01L 3/00

(52) U.S. Cl. CPC B01L 3/508
USPC 422/547

(57) ABSTRACT

The present invention provides a chip which can be used for preventing the contamination in the inside of a measurement device, and comprises: a contact hole that is in contact with a solution of interest and that is formed on an outer surface of the chip for the purpose of introducing blood that makes contact with the contact hole into the inside of the chip; a first hydrophobic region that is substantially in contact with at least a part of an opening edge of the contact hole and that is formed on the outer surface of the chip from a contact hole toward the chip insertion side; and a first hydrophilic region that is located adjacent to the first hydrophobic region and that is formed on the outer surface of the chip from the first hydrophobic region toward the chip insertion side.

### FIELD OF THE ART

This invention relates to a chip for analysis of a solution of interest that is inserted into an inside of a measurement device and that is for analyzing a solution of interest by the use of the measurement device.

### BACKGROUND ART

A conventional chip for analysis of a solution of interest is, as shown in the patent document 1, of a lengthy shape having a projection on one side surface in a plane view, and comprises a contact hole to which blood as being a solution of interest makes contact, an analyzing part for analyzing the blood and a transporting path that communicates the contact hole and the analyzing part and that transports the blood to the analyzing part by means of a capillary phenomenon.

Whole of each substrate constituting the chip for analysis of solution of interest is provided with a hydrophilic treatment to make an inner surface of the transporting path hydrophilic. In case of introducing the blood by the use of the chip for analysis of solution of interest having the above-mentioned arrangement, if a circumference of the contact hole has a hydrophilic property, since the blood that makes contact with the contact hole tends to spread not only in the contact hole but also in the circumference of the contact hole, it becomes difficult to smoothly introduce the blood into the contact hole. As a result of this, conventionally it is devised that a hydrophobic treatment is provided to the circumference of the contact hole of an outer surface of the chip so as to make it easily to introduce the blood into the contact hole. The hydrophobic treatment is conducted by, for example, pasting a hydrophobic tape on the circumference of the contact hole on the outer surface of the chip.

However, with an arrangement wherein the hydrophobic treatment is provided on the circumference of the contact hole, a droplet of the blood that has once attached to a hydrophobic area tends to move as it is. As a result of this, in case of inserting the chip for analysis of solution of interest into a measurement device, when the chip is tilted so as to locate an insertion side on a lower side, there is a problem that the droplet of the blood enters inside of the measurement device so that the inside of the measurement device is polluted.

### PRIOR ART DOCUMENTS

### Patent Document

Patent document 1: Japanese Unexamined Patent Application Publication No. 2009-175118

### DISCLOSURE OF THE INVENTION

### Problems to be Solved by the Invention

A main object of this invention is to prevent an inside of a measurement device from being polluted because the blood that has attached to the vicinity of a contact hole flows along an outer surface of the chip into an insertion side while smoothly introducing a solution of interest into the contact hole.

### Means to Solve the Problems

More specifically, the chip for analysis of solution of interest in accordance with this invention is a chip for analysis of solution of interest that is inserted into an inside of a measurement device and that is for analyzing a solution of interest, and is characterized by comprising a contact hole that is in contact with the solution of interest and that is formed on an outer surface of the chip for the purpose of introducing the solution of interest that makes contact with the contact hole into the inside of the chip, a first hydrophobic region that is substantially in contact with an opening edge of the contact hole and that is formed from the contact hole to a chip insertion side on the outer surface of the chip, and a first hydrophilic region that is located adjacent to the first hydrophobic region and that is formed from the first hydrophobic region to the chip insertion side on the outer surface of the chip. A concept that the first hydrophobic region is substantially in contact with the opening edge of the contact hole includes a state wherein the first hydrophobic region makes contact with the opening edge with a little space formed therebetween in addition to a state wherein the first hydrophobic region makes contact with the opening edge.

In accordance with this arrangement, since the first hydrophobic region is formed to make the contact hole and the opening edge substantially in contact each other, it is possible to introduce the solution of interest into the contact hole smoothly. In addition, since the first hydrophobic region and the first hydrophilic region are formed in this order from the contact hole to the chip insertion side, it is possible to prevent the solution of interest from moving in a state of droplets so that the inside of the measurement device can be prevented from being polluted by the solution of interest.

In addition, it is preferable that the chip for analysis of solution of interest in accordance with this invention further comprises a second hydrophobic region that is located adjacent to the first hydrophilic region and that is formed from the first hydrophilic region to the chip insertion side on the outer surface of the chip. With this arrangement, since the first hydrophobic region, the first hydrophilic region and the second hydrophobic region are formed in this order from the contact hole to the chip insertion side, the solution of interest that has moved from the first hydrophobic region is hard to move to the first hydrophilic region so that the solution of interest can be held in the first hydrophilic region. With this arrangement, in case of inserting the chip for analysis of solution of interest into the measurement device, even though the solution of interest that has attached to the first hydrophobic region moves to the chip insertion side, the solution of interest can be held in midstream. As a result, it is possible to prevent inside of the measurement device from being polluted by the solution of interest.

In order to further prevent the inside of the measurement device from being polluted by the solution of interest by making the above-mentioned effect more significant, it is preferable that a boundary between the first hydrophilic region and the second hydrophobic region is located outside of the measurement device in a state that the chip is inserted into the measurement device.

In a state that a user holds the chip for analysis of solution of interest, in order not to pollute a hand of the user due to the solution of interest, it is preferable to comprise a grip part that is arranged on an opposite side to the chip insertion side and that is gripped in case that the chip is inserted into the inside of the measurement device, a second hydrophilic region that is located adjacent to the first hydrophobic region and that is formed from the first hydrophobic region to a grip part side on the outer surface of the chip, and a third hydrophobic region that is located adjacent to the second hydrophilic region and that is formed from the second hydrophilic region to the grip part side on the outer surface of the chip.

As a concrete example of the contact hole and in order to preferably prevent the measurement device from being polluted due to the solution of interest, it is preferable that the contact hole opens from a side surface of the chip to a back surface of the chip and the first hydrophobic region and the first hydrophilic region are formed on the back surface of the chip. Similarly, it is preferable that the second hydrophilic region and the third hydrophobic region are formed on the back surface of the chip. With this arrangement, even though a case that unnecessary solution of interest attaches to the vicinity of the contact hole is unrecognized because the back surface of the chip is difficult to be recognized by the user, it is possible to preferably prevent pollution.

### Effect of the Invention

In accordance with the present claimed invention having the above arrangement, it is possible to prevent the inside of the measurement device from being polluted because the blood that has attached to the vicinity of the contact hole flows along an outer surface of the chip into the insertion side while smoothly introducing the solution of interest into the contact hole.

### BRIEF DESCRIPTION OF THE DRAWINGS

FIG. 1 is a view showing a chip for analysis of solution of interest and a concentration measurement device of this embodiment.

FIG. 2 is a perspective view of the chip for analysis of solution of interest of this embodiment.

FIG. 3 is a plane view of the chip for analysis of solution of interest of this embodiment.

FIG. 4 is a pattern cross-sectional view showing an internal configuration of the chip for analysis of solution of interest.

FIG. 5 is a bottom view of the chip for analysis of solution of interest of this embodiment.

FIG. 6 is a bottom view of a gang printing sheet of the chip for analysis of solution of interest of this embodiment.

FIG. 7 is a bottom view of the chip for analysis of solution of interest of a modified embodiment.

### EXPLANATION OF CODES

100 . . . chip for analysis of solution of interest
Z . . . concentration measurement device
1b . . . back surface of chip
2 . . . contact hole
2a . . . opening edge
6 . . . grip part
A1 . . . first hydrophobic region
B1 . . . first hydrophilic region
A2 . . . second hydrophobic region
B2 . . . second hydrophilic region
A3 . . . third hydrophobic region

### BEST MODES OF EMBODYING THE INVENTION

A chip for analysis of solution of interest 100 in accordance with this embodiment is used for a concentration measurement device (Z) using an electrode sensor Z3.

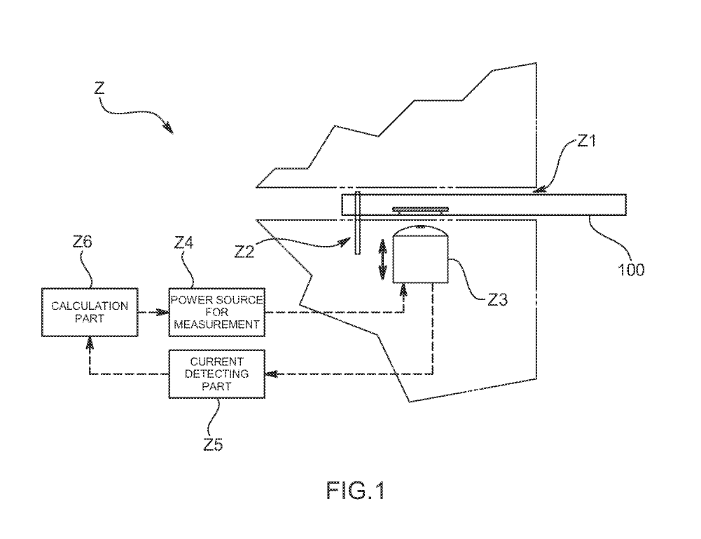

The concentration measurement device (Z) is for measuring, for example, a blood-sugar level in blood, and comprises, as shown in FIG. 1, an insertion hole Z1 into which the chip for analysis of solution of interest 100 is inserted, a positioning mechanism Z2 that positions the chip for analysis of solution of interest 100 inserted into the insertion hole Z1, an enzyme electrode sensor Z3 that makes a back and forth movement relative to the positioned chip for analysis of solution of interest 100, a power source for measurement Z4 that applies voltage for measurement to the enzyme electrode sensor Z3, a current detecting part Z5 that detects an electric current output by the enzyme electrode sensor Z3, and a calculation part Z6 that controls the power source for measurement Z4, that conducts a differential operation on the detected current and that calculates a concentration of an object to be measured in the solution of interest by detecting the maximum value of the derivative value. A platinum (Pt) electrode is formed at a distal end of the enzyme electrode sensor Z3 and a surface of the platinum electrode is coated with a glucose oxidase (GOD) immobilized film.

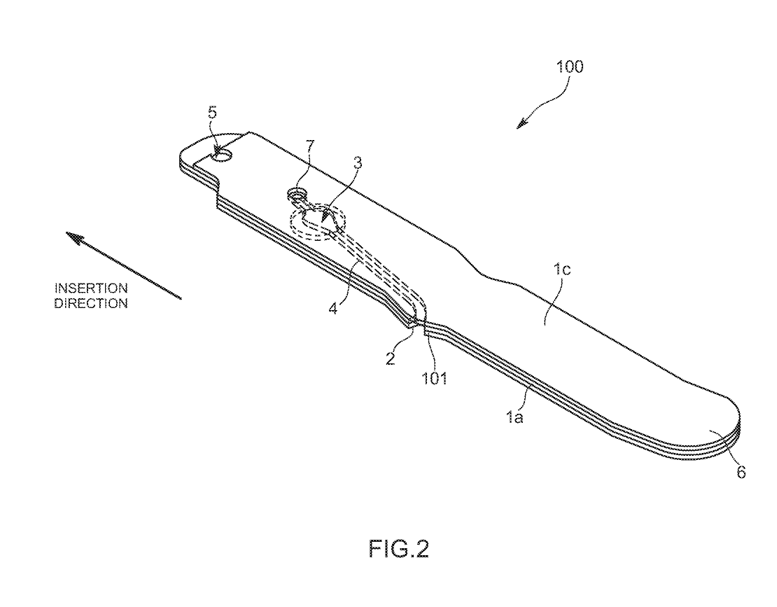

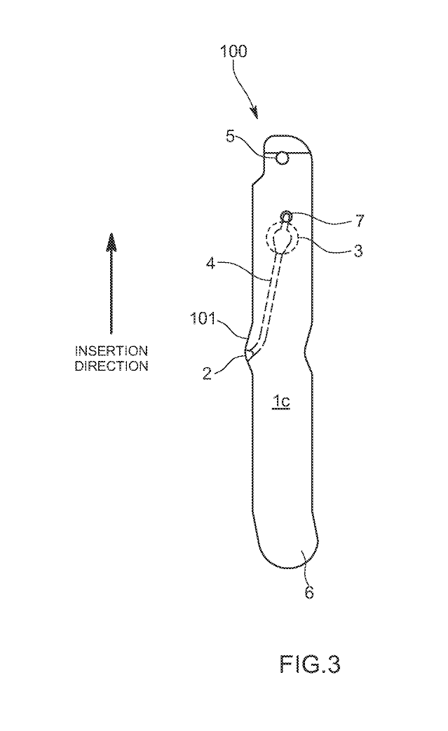

Concretely, as shown in FIG. 2 and FIG. 3, the chip for analysis of solution of interest 100 is of a lengthy shape having a projection on a part of a side surface in a plane view, and comprises a contact hole 2 that makes contact with blood in providing portion of a solution of interest (a providing portion of the blood, for example, a finger or the like), an analyzing part 3 for analyzing the blood, and a transporting path 4 that communicates the contact hole 2 with the analyzing part 3 and that transports the blood to the analyzing part 3 by means of the capillary phenomenon. The chip for analysis of solution of interest 100 is provided with a positioning hole 5 into which a pin of the positioning mechanism Z2 is inserted.

The contact hole 2 is formed on a projecting part 101 that projects in an outside in a plane view, and concretely, the contact hole 2 is formed from a side surface 1a to a back surface (a bottom surface) of the chip 100 near the most top part (the most outside part) of the projecting part 101 in a plane view. The contact hole 2 is so formed to locate in an outside part (outside of the insertion hole Z1) of the concentration measurement device (Z) in a state that the contact hole 2 is inserted into the insertion hole Z1 of the concentration measurement device (Z).

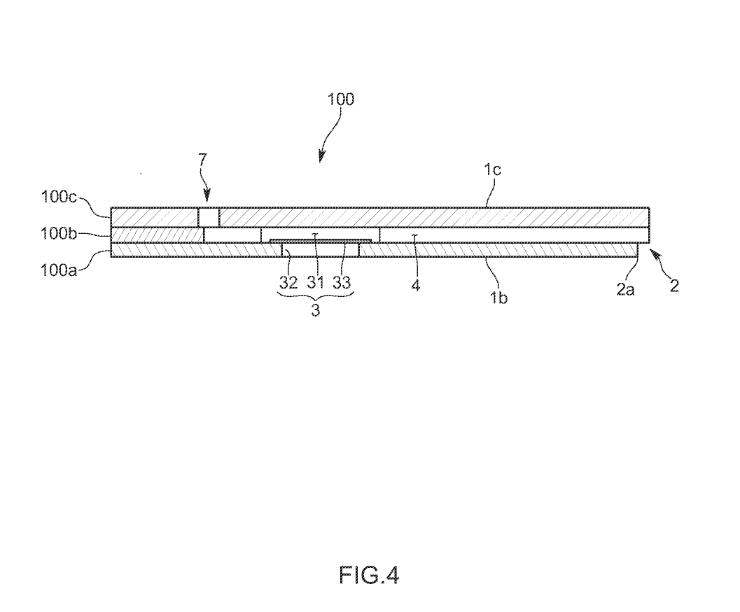

The analyzing part 3 is, as shown in FIG. 3 and FIG. 4, for making a non-blood cell component such as blood plasma and serum other than a blood cell in the blood transported by the transporting path 4 contact with the enzyme electrode sensor Z3, and comprises a solution of interest storing part 31 that is arranged in an upstream side of an air hole 7 in the transporting path 4 and a width of whose flow channel expands, an opening part for analysis 32 that is in communication with the outside on a side wall forming the solution of interest storing part 31, and a separation membrane 33 that is arranged on the opening part for analysis 32 and that separates the plasma and the serum as being the object to be measured in the blood and passes the plasma and the serum through the opening part for analysis 32. The air hole 7 is for discharging the air associated with introducing the blood.

The opening part for analysis 32 is, as shown in FIG. 4, formed on a surface (a back surface 1b) opposite to a surface (a top surface 1c) where the air hole 7 is formed. The enzyme electrode sensor Z3 makes contact with the opening part for analysis 32.

The separation membrane 33 is a, for example, polyethylene terephthalate (PET) membrane having a plurality of micro holes through which the non-blood cell component such as blood plasma and serum other than a blood cell in the blood passes. The separation membrane 33 may be made of polycarbonate.

The transporting path 4 makes, as shown in FIG. 3 and FIG. 4, the contact hole 2 and the analyzing part 3 in communication with each other, and extends in the downstream side of the analyzing part 3, and the air hole 7 is formed in the downstream side of the analyzing part 3. Concretely, the transporting path 4 is formed to extend in a longitudinal direction from the contact hole 2 toward a distal end part. An inner surface of a flow channel in the transporting path 4 is provided with a hydrophilic treatment. Concretely, the hydrophilic treatment is provided on at least a bottom base plate and a top base plate constituting the transporting path 4. In this embodiment, the transporting path 4 is formed of a sheet made of resin such as polyethylene terephthalate (PET), acrylic or the like on a surface of which provided is a hydrophilic coating. The hydrophilic treatment may be added by means of a plasma treatment. A grip part 6 that is gripped by an operator in case of inserting the chip for analysis of solution of interest 100 into the inside of the concentration measurement device (Z) is formed on a rear end part (an end part opposite to an insertion side) of the chip 100 in the longitudinal direction, in other words, a part opposite to the distal end part (an end part of the insertion side) that is inserted into the concentration measurement device (Z) as being a measurement device, of the chip 100 in the longitudinal direction. The grip part 6 includes a top surface (a surface 1c) of the end part opposite to the insertion side) and a bottom surface (a back surface 1b). The end part of the insertion side is a distal end part in a direction of being inserted in FIG. 3. The grip part 6 is located outside (outside of the insertion hole Z1) of the concentration measurement device (Z) in a state that the chip for analysis of solution of interest 100 is inserted into the insertion hole Z1 of the concentration measurement device (Z).

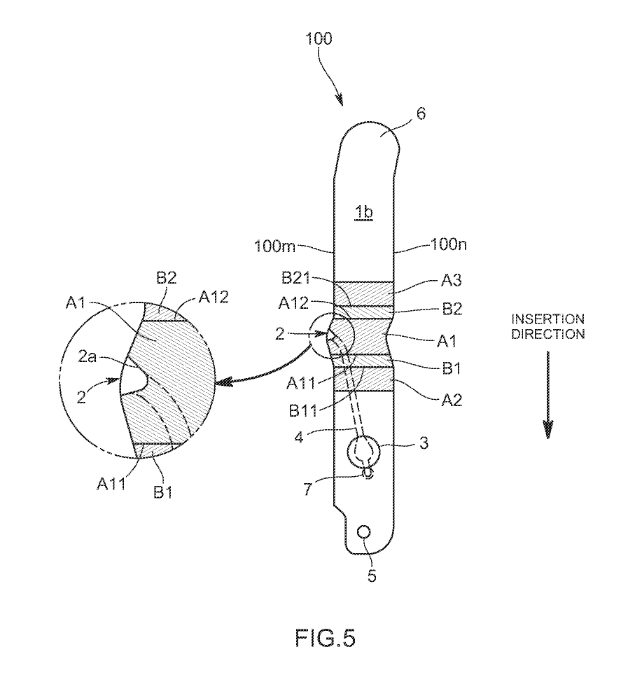

As shown in FIG. 5, the chip for analysis of solution of interest 100 of this embodiment has an arrangement that a hydrophobic (water-shedding) region, a hydrophilic region and a hydrophobic (water-shedding) region are formed alternately in this order from the bottom surface side opening edge 2a of the contact hole 2 on the back surface 1b of the chip 100 toward the chip insertion side, and a hydrophobic (water-shedding) region, a hydrophilic region and a hydrophobic (water-shedding) region are formed alternately in this order from the bottom surface side opening edge 2a of the contact hole 2 on the back surface 1b of the chip 100 toward the direction opposite to the chip insertion side.

Concretely, the chip for analysis of solution of interest 100 has a first hydrophobic region A1 that makes in contact with the bottom surface side opening edge 2a of the contact hole 2 and formed on the contact hole 2 of the back surface 1b toward a chip insertion side, a first hydrophilic region B1 formed adjacent to the first hydrophobic region A1 and on the back surface 1b from the first hydrophobic region A1 toward the chip insertion side, and a second hydrophobic region A2 formed adjacent to the first hydrophilic region B1 and on the back surface 1b from the first hydrophilic region B1 to the chip insertion side.

In addition, the chip for analysis of solution of interest 100 has a second hydrophilic region B2 that is arranged adjacent to the first hydrophobic region A1 and that is formed on the back surface 1b from the first hydrophobic region A1 to the grip part 6 side (the side opposite to the chip insertion side) and a third hydrophobic region A3 that is arranged adjacent to the second hydrophilic region B2 and that is formed on the back surface 1b from the second hydrophilic region B2 to the grip part 6 side.

The first hydrophobic region A1 is formed on the back surface 1b to intersect in a longitudinal direction with including the contact hole 2. In other words, the first hydrophobic region A1 is formed on the back surface 1b to range from one end side part 110m to the other end side part 100n. A total length of the first hydrophobic region A1 in the longitudinal direction is about 6 mm while 3 mm to the insertion side and 3 mm to the side opposite to the insertion side with a central focus in the longitudinal direction on the contact hole 2.

The first hydrophilic region B1 is formed on the back surface 1b in a predetermined range from an insertion side end A11 of the first hydrophobic region A1. Concretely, the first hydrophilic region B1 is formed from one end side part 100m to the other end side part 100n and a longitudinal length of the first hydrophilic region B1 is about 2 mm.

The second hydrophobic region A2 is formed on the back surface 1b in a predetermined range from an insertion side end B 11 of the first hydrophilic region B1. Concretely, the second hydrophobic region A1 is formed from one end side part 100m to the other end side part 100n and a longitudinal length of the second hydrophobic region A2 is about 4 mm.

The second hydrophilic region B2 is formed on the back surface 1b in a predetermined range from an anti-insertion side end A12 of the first hydrophobic region A1. In addition, the second hydrophilic region B2 is formed in the insertion side from the grip part 6. Concretely, the second hydrophilic region B2 is formed from one end side part 100m to the other end side part 100n and a longitudinal length of the second hydrophilic region B2 is about 2 mm.

The third hydrophobic region A3 is formed on the back surface 1b in a predetermined range from an anti-insertion side end B21 of the second hydrophilic region B2. Concretely, the third hydrophobic region A3 is formed from one end side part 100m to the other end side part 100n and a longitudinal length of the third hydrophobic region A3 is about 4 mm.

In a state that the chip for analysis of solution of interest 100 is inserted into the measurement device Z1, the hydrophobic regions A1˜A3 and the hydrophilic regions B1˜B2, are so formed to locate a boundary (the insertion side end B11 of the first hydrophilic region B1) between the first hydrophilic region B1 and the second hydrophobic region A2 in an outside (outside of the insertion hole Z1) of the concentration measurement device (Z).

Next, a method for manufacturing the chip for analysis of solution of interest 100 having the above-mentioned arrangement will be briefly explained.

The chip for analysis of solution of interest 100 of this embodiment is, as shown in FIG. 4, made of a three-layered structure comprising a bottom base plate 100a, a middle base plate 100b and a top base plate 100c. The bottom base plate 100a and the middle base plate 100b are adhered and the middle base plate 100b and the top base plate 100c are adhered respectively.

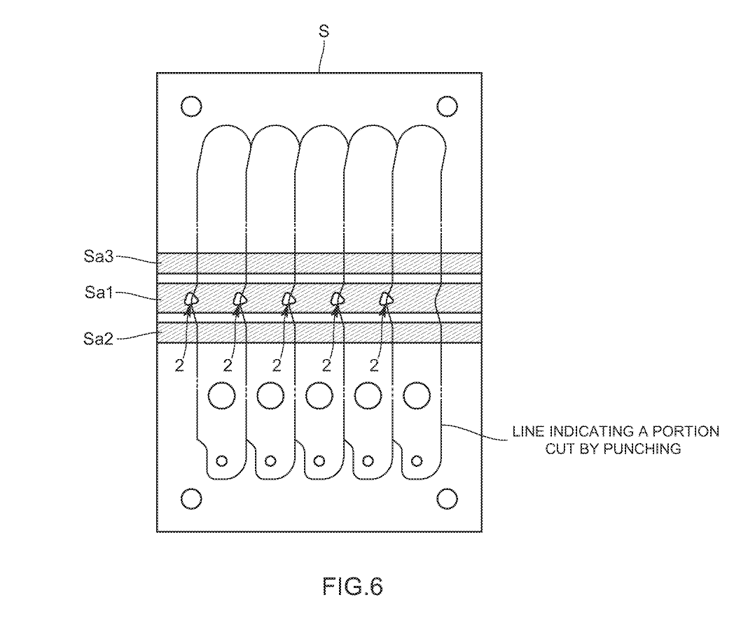

The chip for analysis of solution of interest 100 is formed by cutting off by means of a punching process such as punching a gang printing sheet (S) (refer to FIG. 6) formed by laminating a bottom base plate sheet constituting the bottom base plate 100a, a middle base plate sheet constituting the middle base plate 100b and a top base plate sheet constituting the top base plate 100c.

Whole of a back surface (a back surface of the bottom base plate) of the gang printing sheet (S) is provided with a hydrophilic treatment, and then a hydrophobic coating is printed on the back surface of the gang printing sheet (S) with which the hydrophilic treatment is provided as shown in FIG. 6.

A first hydrophobic coating Sa1 printed in the middle among the hydrophobic coatings is printed to cover the contact hole 2 of each chip for analysis of solution of interest 100 and forms the first hydrophobic region A1 of each chip for analysis of solution of interest 100. A second hydrophobic coating Sa2 printed in the insertion side of the first hydrophobic coating Sa1 forms the second hydrophobic region A2 of each chip for analysis of solution of interest 100. In addition, a region between the first hydrophobic coating Sa1 and the second hydrophobic coating Sa2 serves as the first hydrophilic region B1. Meanwhile, the third hydrophobic coating Sa3 printed in the anti-insertion side of the first hydrophobic coating Sa1 forms the third hydrophobic region A3 of each chip for analysis of solution of interest 100. In addition, a region between the first hydrophobic coating Sa1 and the third hydrophobic coating Sa3 serves as the second hydrophilic region B2.

The gang printing sheet (S) on the back surface of which the hydrophobic coatings Sa1˜Sa3 are printed is punched out by the use of a metal mold having a knife edge whose shape is that of the chip for analysis of solution of interest 100 in plane view. With this procedure, the chip for analysis of solution of interest 100 on the back surface of which the hydrophobic regions A1˜A3 and the hydrophilic regions B1 and B2 are formed is made.

### Effect of this Embodiment

In accordance with the chip for analysis of solution of interest 100 of this embodiment having the above-mentioned arrangement, since the first hydrophobic region A1 is formed to make contact with the bottom surface side opening edge 2a of the contact hole 2, it becomes possible to smoothly introduce the solution of interest into the contact hole 2. In addition, since the first hydrophobic region A1, the first hydrophilic region B1 and the second hydrophobic region A2 are formed in this order from the contact hole 2 to the insertion side, the solution of interest that has moved from the first hydrophobic region A1 is hard to move to the first hydrophilic region B1 so that the solution of interest can be held in the first hydrophilic region B1. With this arrangement, in case of inserting the chip for analysis of solution of interest 100 into the measurement device (Z), even though the solution of interest that has attached to the first hydrophobic region A1 moves to the chip insertion side, the solution of interest can be held in midstream. As a result, it is possible to prevent inside of the measurement device (Z) from being polluted by the solution of interest.

In addition, since the first hydrophobic region A1, the second hydrophilic region B2 and the third hydrophobic region A3 are formed in this order from the contact hole 2 to the anti-insertion side, the solution of interest that has moved from the first hydrophobic region A1 is hard to move to the second hydrophilic region B2 so that the solution of interest can be held in the second hydrophilic region B2. With this arrangement, in case of operating the chip for analysis of solution of interest 100, even though the solution of interest that has attached to the first hydrophobic region A1 moves to the anti-insertion side, the solution of interest can be held in midstream. As a result of this, it is possible to prevent the hand that holds the chip 100 from being polluted by the solution of interest.

### Other Modified Embodiment

The present claimed invention is not limited to the above-mentioned embodiment.

For example, the hydrophobic region and the hydrophilic region are alternately formed only on the back surface of the chip for analysis of solution of interest in the above-mentioned embodiment, however, the hydrophobic region and the hydrophilic region may be formed also on a front surface of the chip with the same manner as that of the back surface. With this arrangement, even though the solution of interest attaches to the front surface of the chip, the same effect as that of the above-mentioned embodiment can be produced.

In addition, the second hydrophilic region and the third hydrophobic region are formed in the anti-insertion side in the above-mentioned embodiment, however, they may not be formed. Furthermore, the contact hole opens ranging from the side surface to the back surface of the chip in the above-mentioned embodiment, however it may open on the side surface of the chip alone or it may open ranging from the back surface to the front surface of the chip.

In addition, a longitudinal length of the first hydrophobic region, the first hydrophilic region, the second hydrophobic region, the second hydrophilic region and the third hydrophobic region may be set arbitrarily. For example, the second hydrophobic region may be formed ranging from the insertion side end of the first hydrophilic region to the insertion side distal end part, or may be formed to reach the analyzing part.

Furthermore, the third hydrophobic region may be formed ranging from the anti-insertion side end of the second hydrophilic region to whole of the grip part. With this arrangement, it is possible to make the solution of interest difficult to attach to a hand.

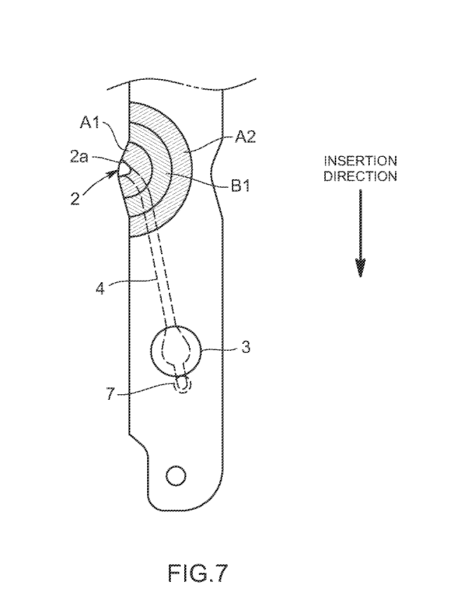

In addition, in the above-mentioned embodiment, the hydrophobic regions and the hydrophilic regions are formed ranging from one end side part to the other end side part of the chip, however, as shown in FIG. 7, it may be so arranged that the first hydrophobic region A1 is a region of a partial circular shape, the first hydrophilic region B1 is a region of a partial annular shape and the second hydrophobic region A2 is a region of a partial annular shape so as to make each boundary between the regions generally concentric with a focus on the contact hole. In other words, it may be so arranged that the hydrophobic region, the hydrophilic region and the hydrophobic region are arranged in this order from the contact hole to the insertion side or the anti-insertion side.

The present claimed invention is not limited to the above-mentioned embodiment, and it is a matter of course that the present claimed invention may be variously modified without departing from a spirit of the invention.

### POSSIBLE APPLICATIONS IN INDUSTRY

In accordance with this invention, it is possible to prevent the inside of the measurement device from being polluted because the blood that has attached to the vicinity of the contact hole flows along the outer surface of the chip into the insertion side while smoothly introducing the solution of interest into the contact hole.

1. A chip for analysis of solution of interest that is inserted into an inside of a measurement device and that is for analyzing a solution of interest, wherein comprising
a contact hole that is in contact with the solution of interest and that is formed on an outer surface of the chip for the purpose of introducing the solution of interest that makes contact with the contact hole into the inside of the chip,
a first hydrophobic region that is substantially in contact with an opening edge of the contact hole and that is formed from the contact hole to a chip insertion side on the outer surface of the chip, and
a first hydrophilic region that is located adjacent to the first hydrophobic region and that is formed from the first hydrophobic region to the chip insertion side on the outer surface of the chip.

2. The chip for analysis of solution of interest described in claim 1, and further comprising
a second hydrophobic region that is located adjacent to the first hydrophilic region and that is formed from the first hydrophilic region to the chip insertion side on the outer surface of the chip.

3. The chip for analysis of solution of interest described in claim 1, wherein comprising
a grip part that is arranged on an opposite side to the chip insertion side and that is gripped in case that the chip is inserted in the inside of the measurement device,
a second hydrophilic region that is located adjacent to the first hydrophobic region and that is formed from the first hydrophobic region to a grip part side on the outer surface of the chip, and
a third hydrophobic region that is located adjacent to the second hydrophilic region and that is formed from the second hydrophilic region to the grip part side on the outer surface of the chip.

4. The chip for analysis of solution of interest described in claim 2, wherein
a boundary between the first hydrophilic region and the second hydrophobic region is located outside of the measurement device in a state that the chip is inserted into the measurement device.

5. The chip for analysis of solution of interest described in claim 1, wherein
the contact hole opens from a side surface of the chip to a back surface of the chip and
the first hydrophobic region and the first hydrophilic region are formed on the back surface of the chip.
